(19) United States
(12) Patent Application Publication
(10) Pub. No.: US 2015/0183209 A1
(43) Pub. Date: Jul. 2, 2015

(54) PASTE SUPPLY APPARATUS, SCREEN PRINTING MACHINE AND PASTE SUPPLY METHOD

(71) Applicant: Panasonic Intellectual Property Management Co., Ltd., Osaka (JP)

(72) Inventors: Hideki UCHIDA, Yamanashi (JP); Masaaki TOKUNAGA, Yamanashi (JP)

(21) Appl. No.: 14/570,420

(22) Filed: Dec. 15, 2014

(30) Foreign Application Priority Data
Dec. 27, 2013 (JP) 2013-271270

(51) Int. Cl. B41F 15/44

(52) U.S. Cl. CPC B41F 15/44

(57) ABSTRACT

A paste supply method using a paste pot that includes a tubular container which receives paste and is provided with a through hole in a bottom part thereof and an inner lid movable inside the tubular container. The method includes: fixing and holding the paste pot in a posture in which the through hole faces downwardly; ejecting paste from the through hole by downwardly moving a pad member abutted from above on the inner lid of the paste pot held and depressing the inner lid inside the tubular container; and sucking up paste dripping from the through hole inside the tubular container by depressing the inner lid and then upwardly moving the pad member joined to the inner lid and pulling up the inner lid.

### CROSS REFERENCE TO RELATED APPLICATION(S)

The present disclosure relates to the subject matters contained in Japanese Patent Application No. 2013-271270 filed on Dec. 27, 2013, which are incorporated herein reference in its entirety.

### FIELD

One or more embodiments of the present invention relate to a paste supply apparatus for supplying paste to a mask contacted with a substrate in a screen printing machine, the screen printing machine and a paste supply method.

### BACKGROUND

As a paste supply apparatus for supplying paste to a mask brought into contact with a substrate in a screen printing machine, there is an apparatus for ejecting and supplying paste to a mask from a syringe in which the paste is stored (see Patent Reference 1, for instance). The paste stored in the syringe is supplied in a state sealed in a container called a paste pot including a tubular container and an inner lid fitted into this tubular container, and a paste supply apparatus constructed so as to use the paste pot itself as a syringe rather than shifting paste from this paste pot to the syringe is also known (see Patent Reference 2, for instance). In this case, after the paste pot is held in a posture in which a through hole provided in a bottom part of the tubular container faces downwardly, a pad member is abutted on an upper surface of the inner lid and is depressed to thereby eject the paste from the through hole of the tubular container. In this case, as means for depressing the pad member, for example, a cylinder in which the pad member is attached to the lower end of a piston rod is used.

Patent Reference 1 is JP-A-2011-140176 and Patent Reference 2 is JP-A-2010-172928.

### SUMMARY

However, in the paste supply apparatus using the above-described paste pot, even when depression of the pad member is stopped in order to attempt to stop ejection of paste, it may take a long time (in some cases, several minutes) to stop drips of the paste from the through hole, and this became a fatal problem as the paste supply apparatus.

Hence, one of objects of the invention is to provide a paste supply apparatus, a screen printing machine and a paste supply method capable of preventing drips of paste at the time of stopping election of the paste.

According to an aspect of an embodiment of the invention, there is provided a paste supply apparatus including: a pot holding part that fixes and holds a paste pot that includes a tubular container which receives paste and is provided with a through hole in a bottom part of the tubular container and an inner lid movable inside the tubular container, in a posture in which the through hole faces downwardly, a pad member that abuts on an upper surface of the inner lid of the paste pot held in the pot holding part; a pad member elevation part that upwardly and downwardly moves the pad member inside the tubular container; a joining part that joins the inner lid to the pad member; and a control part that controls the pad member elevation part to execute operation in which the pad member is downwardly moved to depress the inner lid in order to eject paste from the through hole and the pad member joined to the inner lid by the joining part is upwardly moved to pull up the inner lid in order to stop ejection of the paste from the through hole.

According to another aspect of the embodiment of the invention, there is provided a screen printing machine that prints paste on a substrate, the screen printing machine including: a squeegee that slides on a mask stacked on the substrate; and a paste supply apparatus that supplies paste to the mask, wherein the paste supply apparatus includes: a pot holding part that fixes and holds a paste pot that includes a tubular container which receives paste and is provided with a through hole in a bottom part of the tubular container and an inner lid movable inside the tubular container, in a posture in which the through hole faces downwardly; a pad member that abuts on an upper surface of the inner lid of the paste pot held in the pot holding part; a pad member elevation part that upwardly and downwardly moves the pad member inside the tubular container; a joining part that joins the inner lid to the pad member; and a control part that controls the pad member elevation part to execute operation in which the pad member is downwardly moved to depress the inner lid in order to eject paste from the through hole and the pad member joined to the inner lid by the joining part is upwardly moved to pull up the inner lid in order to stop ejection of the paste from the through hole.

According to still another aspect of the embodiment of the invention, there is provided a paste supply method using a paste pot that includes a tubular container which receives paste and is provided with a through hole in a bottom part of the tubular container and an inner lid movable inside the tubular container, the method including: a pot holding step of fixing and holding the paste pot in a posture in which the through hole faces downwardly; a paste ejecting step of ejecting paste from the through hole by downwardly moving a pad member abutted from above on the inner lid of the paste pot held in the pot holding step and depressing the inner lid inside the tubular container; and a paste suck-up step of sucking up paste dripping from the through hole inside the tubular container by depressing the inner lid in the paste ejecting step and then upwardly moving the pad member joined to the inner lid and pulling up the inner lid.

According to aspects of the embodiment of the invention, drips of paste at the time of stopping ejection of the paste can be prevented.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 is a side view of a screen printing machine in a first embodiment of the invention.

FIG. 2 is a plan view of the screen printing machine in the first embodiment of the invention.

FIG. 3 is an upward perspective view of a squeegee head and a paste supply apparatus included in the screen printing machine in the first embodiment of the invention.

FIG. 4A is an upward perspective view of the paste supply apparatus in the first embodiment of the invention, and FIG. 4B is a partially sectional front view of the paste supply apparatus.

FIG. 5A is an upward perspective view of the paste supply apparatus in the first embodiment of the invention, and FIG. 5B is a downward perspective view of a pot press member constructing the paste supply apparatus.

FIG. 6A is a partially plan view of the paste supply apparatus in the first embodiment of the invention, and FIG. 6B is a sectional view of the paste supply apparatus.

FIG. 7 is a downward perspective view of a pressing cylinder included in the paste supply apparatus in the first embodiment of the invention.

FIG. 8 is a configuration diagram of a suction mechanism included in the paste supply apparatus in the first embodiment of the invention.

Sections (a) to (c) of FIG. 9 are upward perspective views of a paste pot used in the paste supply apparatus in the first embodiment of the invention.

FIGS. 10A and 10B are operation explanatory diagrams of the paste supply apparatus in the first embodiment of the invention.

FIG. 11 is a block diagram showing a control system of the screen printing machine in the first embodiment of the invention.

FIGS. 12A and 12B are operation explanatory diagrams of the screen printing machine in the first embodiment of the invention.

FIGS. 13A to 130 are operation explanatory diagrams at the time of paste suck-up of the paste supply apparatus in the first embodiment of the invention.

FIGS. 14A and 14B are diagrams showing a procedure of replacement work of the paste pot of the paste supply apparatus in the first embodiment of the invention.

FIGS. 15A and 15B are partially sectional side views of a paste supply apparatus in a second embodiment of the invention.

FIGS. 16A and 16B are partially sectional side views of the paste supply apparatus in the second embodiment of the invention.

### DETAILED DESCRIPTION OF THE EMBODIMENTS

### First Embodiment

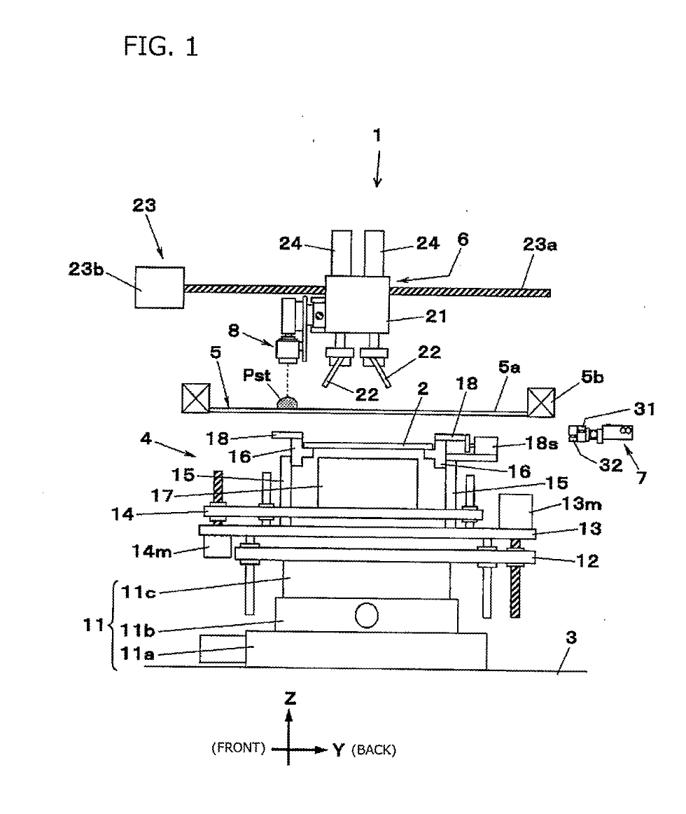

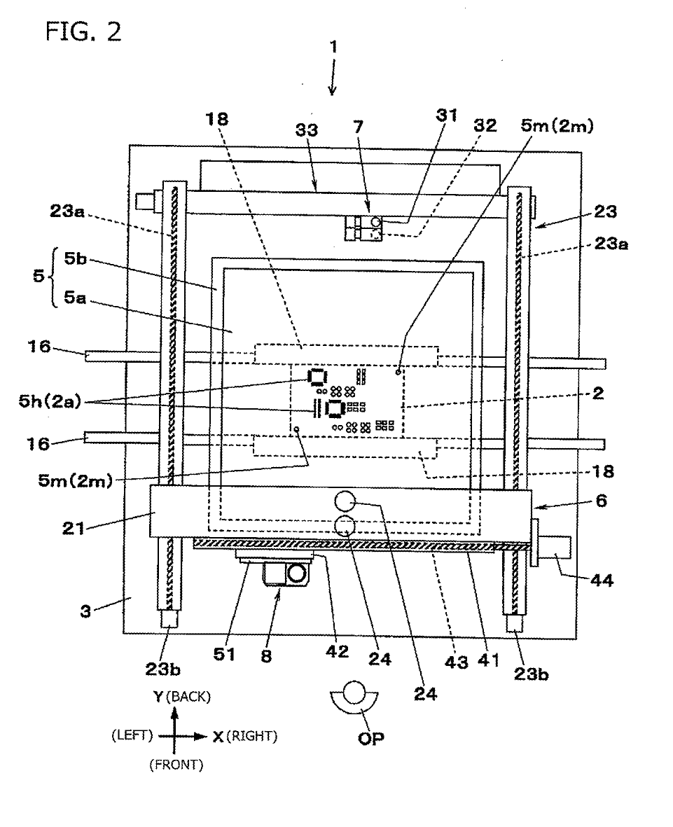

First, a first embodiment of the invention will be described. A screen printing machine 1 shown in FIGS. 1 and 2 is a machine for repeatedly doing screen printing of paste Pst such as solder paste on a substrate 2, and includes a substrate holding movement unit 4 which is formed on a base 3 and holds and moves the substrate 2, a mask 5 horizontally installed over the substrate holding movement unit 4, a squeegee head 6 formed over the mask 5, a camera unit 7 formed under the mask 5, and a paste supply apparatus 8 formed integrally to the squeegee head 6 over the mask 5.

In FIG. 1, the substrate holding movement unit 4 has a configuration including a first elevation table 13 and a second elevation table 14 in this order from the downward side over a base table 12 capable of rotation around the vertical axis and movement in a direction in a horizontal plane by an XYθ movement mechanism 11 formed on the base 3.

The XYθ movement mechanism 11 includes a Y-axis table 11a extending in a Y-axis direction (the front-back direction viewed from an operator OP shown in FIG. 2 and the left-right direction of paper of FIG. 1) on the base 3, an X-axis table 11b formed so as to extend in an X-axis direction (the left-right direction viewed from the operator OP and the direction orthogonal to the paper of FIG. 1) on the Y-axis table 11a and a θ table 11c formed on the X-axis table 11b, and the X-axis table 11b is moved on the Y-axis table 11a in the Y-axis direction by driving of the Y-axis table 11a, and the θ table 11c is moved on the X-axis table 11b in the X-axis direction by driving of the X-axis table 11b, and the base table 12 is rotated around the vertical axis (Z axis) of the paper of FIG. 1 by driving of the θ table 11c. That is, the base table 12 is moved in the horizontal plane by an XYθ movement mechanism 11. The first elevation table 13 is moved upwardly and downwardly with respect to the base table 12 by driving of a first elevation motor 13m, and the second elevation table 14 is moved upwardly and downwardly with respect to the first elevation table 13 by driving of a second elevation motor 14m.

The first elevation table 13 is provided with a pair of conveyor support members 15 extending upwardly. The pair of conveyor support members 15 extends through the second elevation table 14, and supports a pair of conveyance conveyors 16 for conveying the substrate 2 in the X-axis direction on the upper end. An upper surface of the second elevation table 14 is provided with a lower receiving member 17.

A pair of clamp members (clampers 18) oppositely arranged in the X-axis direction is formed over the conveyance conveyors 16. The pair of clampers 18 is opened and closed in the Y-axis direction by actuation of a clamper opening and closing cylinder 18s, and pinches and clamps the substrate 2 received on an upper surface of the lower receiving member 17 in the Y-axis direction.

In FIG. 2, the mask 5 includes a plate part 5a with a flat plate shape extending in an XY plane, and a frame part 5b for holding the outer periphery of the plate part 5a, and the inside of a rectangular region of the plate part 5a surrounded by the frame part 5b is provided with pattern holes 5h corresponding to electrodes 2a on the substrate 2.

In FIG. 2, diagonal positions of the substrate 2 are provided with a set of two substrate side marks 2m, and the plate part 5a of the mask 5 is provided with a set of two mask side marks 5m arranged in correspondence with the substrate side marks 2m. When the substrate 2 is brought into contact with the mask 5 in a state in which the substrate side marks 2m match the mask side marks 5m in plan view, the electrodes 2a of the substrate 2 are matched with the pattern holes 5h of the mask 5.

In FIGS. 1 to 3, the squeegee head 6 is configured to include two squeegees 22 oppositely arranged in the Y-axis direction under a movement base 21 formed so as to extend in the X-axis direction, and the movement base 21 is moved in the Y-axis direction by a head movement mechanism 23. The head movement mechanism 23 is configured to have a pair of head movement ball screws 23a oppositely arranged in the X-axis direction and extending in the Y-axis direction over the mask 5, and two head movement motors 23b for rotating and driving each of the head movement ball screws 23a, and the head movement ball screws 23a are respectively screwed into nut parts formed in the left and right ends of the movement base 21. As a result, when a pair of head movement ball screws 23a is rotated forward or backward in synchronization by the two head movement motors 23b, the movement base 21 is moved in the -axis direction according to this rotation. The two squeegees 22 are individually moved upwardly and downwardly with respect to the movement base 21 by driving of a squeegee elevation cylinder 24 formed on the movement base 21.

In FIGS. 1 and 2, the camera unit 7 is configured to have an upward imaging camera 31 with an imaging visual field turned upwardly and a downward imaging camera 32 with an imaging visual field turned downwardly, and is moved in a horizontal plane by driving of a camera unit movement mechanism 33.

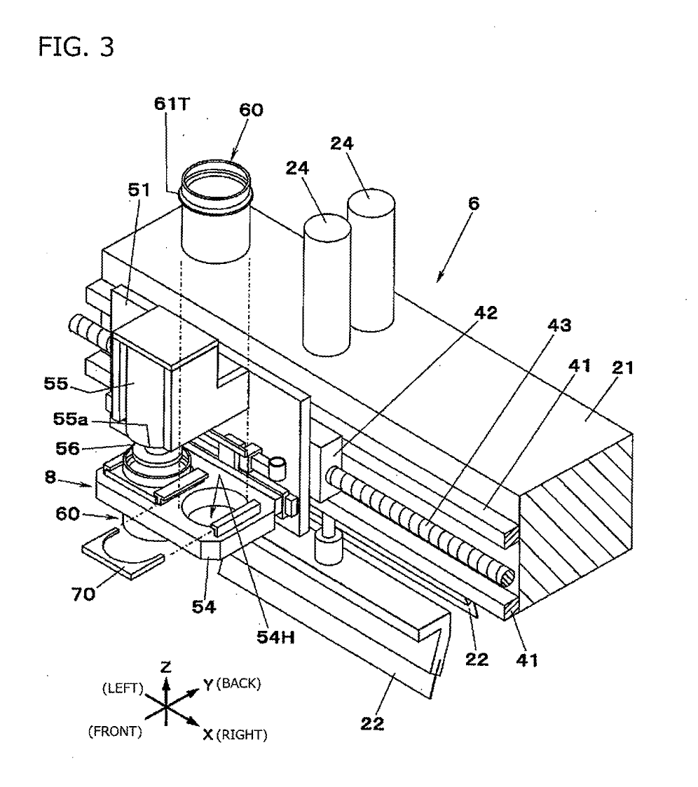

In FIGS. 1 and 2, the paste supply apparatus 8 elects and supplies the paste Pst to the mask 5, and is formed on the front side of the movement base 21. In FIG. 3, a pair of guide members 41 extending in the X-axis direction is vertically arranged in the front of the movement base 21. A base member 51 (described below) which is a component of the paste supply apparatus 8 is attached to the pair of guide members 41 in a state movable in the X-axis direction. A ball screw 43 extending in the X-axis direction is screwed into a nut part 42 attached to the back of the base member 51. When a paste supply apparatus movement motor 44 (FIG. 2) formed on the end of the movement base 21 rotates and drives the ball screw 43, the base member 51 together with the nut part 42 is moved in the X-axis direction.

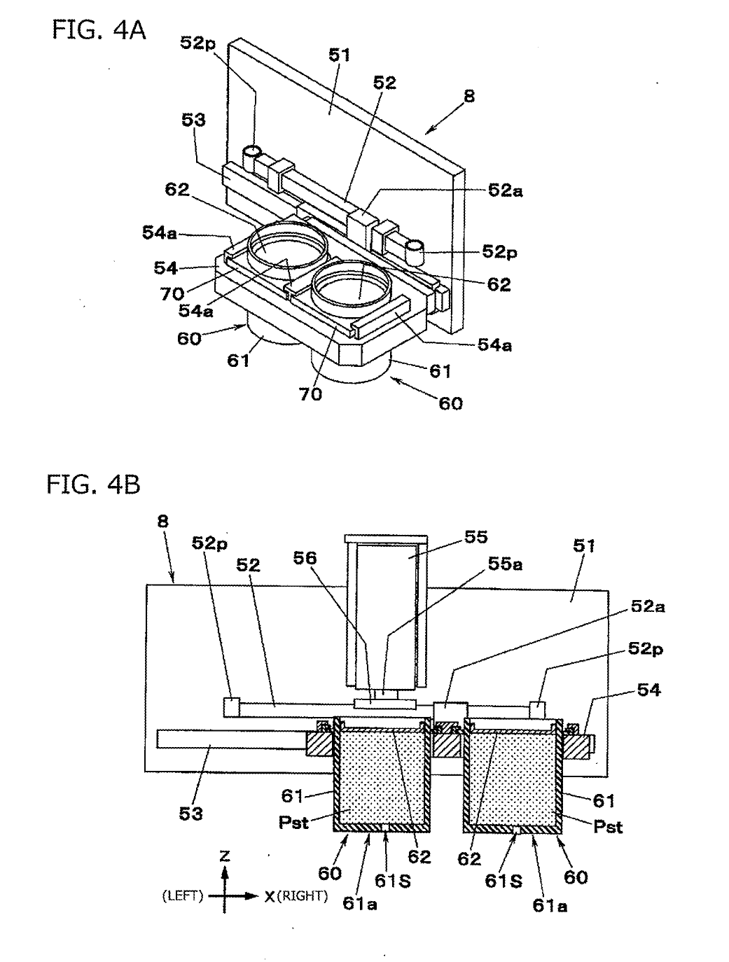

In FIGS. 3, 4A and 4B, the paste supply apparatus 8 includes the plate-shaped base member 51 having the front extending in an XZ plane, a rod-less cylinder 52 attached to the front of the base member 51 with a cylinder tube turned in the X-axis direction, a pot holding part 54 for holding a paste pot 60 described below, and a pressing cylinder 55 fixed and formed in an upper region of the base member 51. The pot holding part 54 is attached to the front of the base member 51 through a guide 53 for guiding this pot holding part 54 in the X-axis direction. Also, the pot holding part 54 is coupled to a moving body 52a of the rod-less cylinder 52. By supplying and draining air to and from left and right ports 52p, the rod-less cylinder 52 moves the moving body 52a in the left-right direction and moves the pot holding part 54 in the X-axis direction.

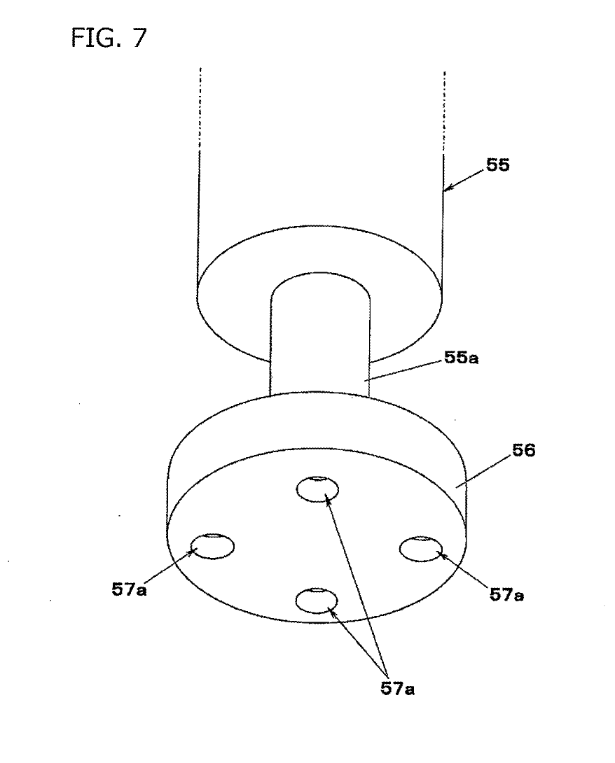

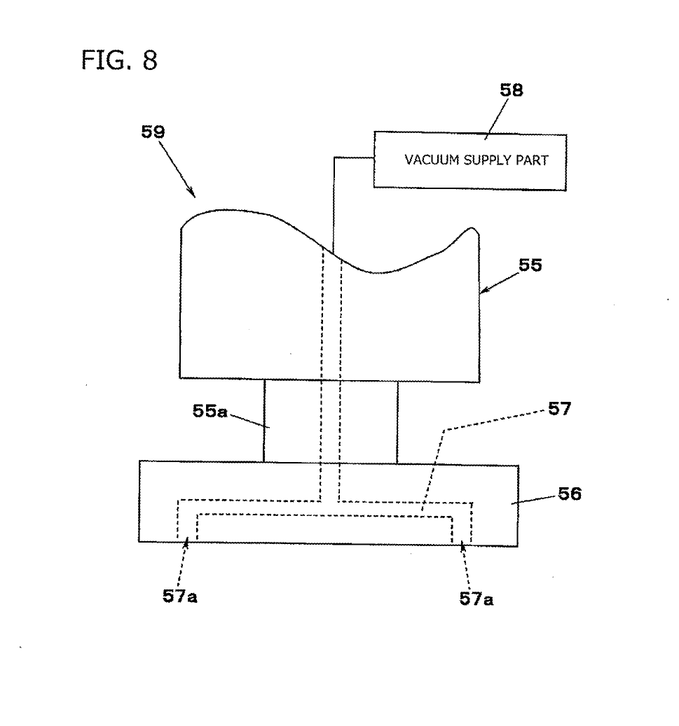

In FIGS. 4B, 7 and 8, the pressing cylinder 55 with a piston rod 55a faced downwardly is attached to the base member 51, and a disk-shaped pad member 56 is attached to the lower end of the piston rod 55a. The pad member 56 is provided with plural suction holes 57a opened in a lower surface of the pad member 56, and a suction path 57 connected to each of the suction holes 57a is formed inside the pad member 56 and the piston rod 55a. A suction part 58 including a vacuum source and a pressure regulating valve is connected to the suction path 57, and when the suction part 58 sucks air of the inside of the suction path 57, a suction force by negative pressure is generated in the suction holes 57a (that is, the lower surface of the pad member 56). That is, in the first embodiment, the suction part 58 constructs a suction mechanism 59 for generating the suction force by negative pressure in the lower surface of the pad member 56.

In FIG. 3, the pot holding part 54 is made of a horizontal plate-shaped member, and has two pot insertion holes 54H arranged in the X-axis direction. The paste pots 60 are detachably held in these two pot insertion holes 54H. In FIGS. 4A, 4B and Sections (a) to (c) of FIG. 9, the paste pot 60 includes a tubular container 61 that receives the paste Pst, and an inner lid 62 provided inside the tubular container 61, and a bottom part 61a of the tubular container 61 is provided with a through hole 61S. The outer edge of the inner lid 62 is upwardly folded back to form a folded-back part 62a, and the inner lid 62 can be moved inside the tubular container 61 so as to slide this folded-back part 62a on an inner wall of the tubular container 61.

The paste pot 60 is inserted into the pot insertion hole 54H in a state changed in a posture in which the through hole 61S faces downwardly (Section (c) of FIG. 9) after a cap CP attached to the end of an open side of the tubular container 61 is detached (from Section (a) of FIG. 9 to Section (b) of FIG. 9). In the paste pot 60 inserted into the pot insertion hole 54H, a brim part 611 formed on a side surface of the tubular container 61 is abutted on an edge part of the pot insertion hole 54H from the upward side.

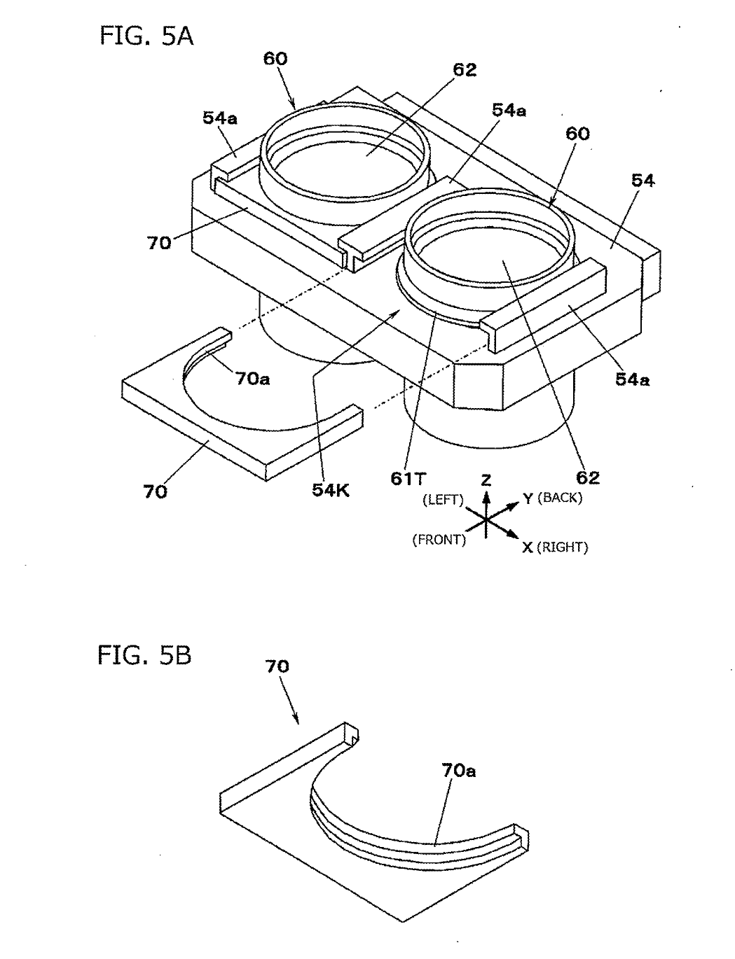

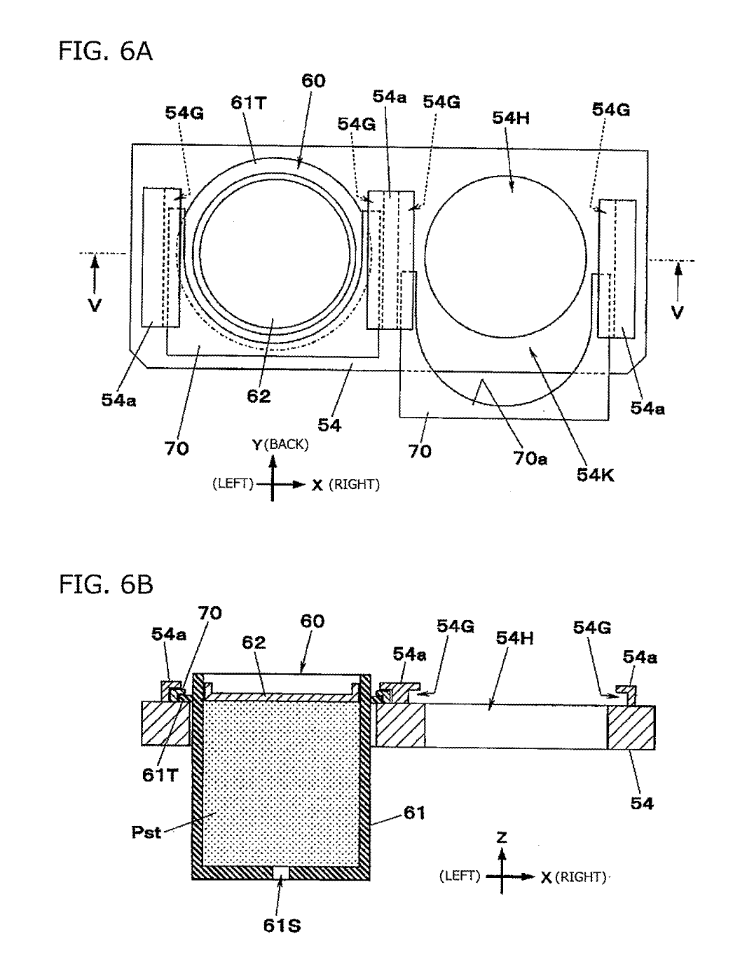

As shown in FIGS. 5A, 5B, 6A and 6B which is a sectional view seen from arrow V-V of FIG. 6A, pot fixture attachment members 54a are formed in a position between the two pot insertion holes 54H and respective positions in which the two pot insertion holes 54H are pinched from the outside of the X-axis direction. A surface of the side facing the pot insertion hole 54H in a side surface of each of the pot fixture attachment members 54a is provided with a guide groove 54G extending in the Y-axis direction. A pair of guide grooves 54G positioned so as to pinch one pot insertion hole 54H in the X-axis direction forms a pot fixture insertion opening 54K opened in the front of the pot holding part 54, and a pot fixture 70 is inserted into its pot fixture insertion opening 54K. The pot fixture 70 is made of a plate-shaped member having a press part 70a with a semicircular shape along an outside diameter of the tubular container 61 of the paste pot 60 and as described above, after the paste pot 60 is attached to the pot insertion hole 54H, the pot fixture 70 is inserted from the pot fixture insertion opening 54K and in this state, the brim part 61T of the paste pot 60 is pressed from the upward side by the press part 70a and the tubular container 61 of the paste pot 60 is fixed and held inside the pot insertion hole 54H. That is, in the first embodiment, the pot holding part 54 includes the pot fixture 70 and thereby, the tubular container 61 of the paste pot 60 inserted into the pot insertion hole 54H can be held in a state in which upward and downward movement is regulated in the pot insertion hole 54H.

In FIGS. 4A and 4B, when the rod-less cylinder 52 moves the pot holding part 54 in the left-right direction (the X-axis direction), one of the two pot insertion holes 54H included in the pot holding part 54 is positioned in a position (hereinafter called a “paste ejection position”) just under the pressing cylinder 55, and the other is positioned in a position (hereinafter called a “pot attachment and detachment position”) deviating from the paste ejection position. In addition, the paste pot 60 is attached to and detached from each of the pot insertion holes 54H of the pot holding part 54 in a state in which its pot insertion hole 54H is positioned in the pot attachment and detachment position.

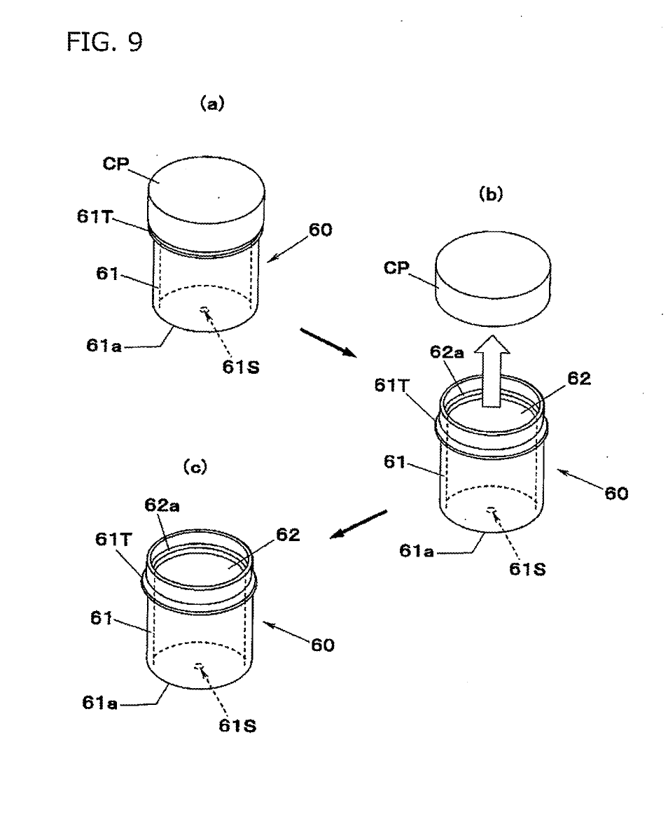

When the pressing cylinder 55 downwardly projects the piston rod 55a and downwardly moves the pad member 56 in a state in which the paste pot 60 is positioned in the paste ejection position, the pad member 56 abuts on an upper surface of the inner lid 62, and the inner lid 62 of the paste pot 60 is depressed inside the tubular container 61 through the pad member 56 (arrow A1 shown in FIG. 10A). Accordingly, the paste Pst is ejected from the through hole 61S (FIG. 10A). Ejection operation of the paste Pst by this pressing cylinder 55 is performed in a state in which the paste supply apparatus movement motor 44 moves the paste supply apparatus 8 over the mask 5 in the X-axis direction. The paste Pst can intermittently be ejected from one paste pot 60 until the inner lid 62 of its paste pot 60 becomes abutting on the bottom part 61a of the tubular container 61 (FIG. 10B).

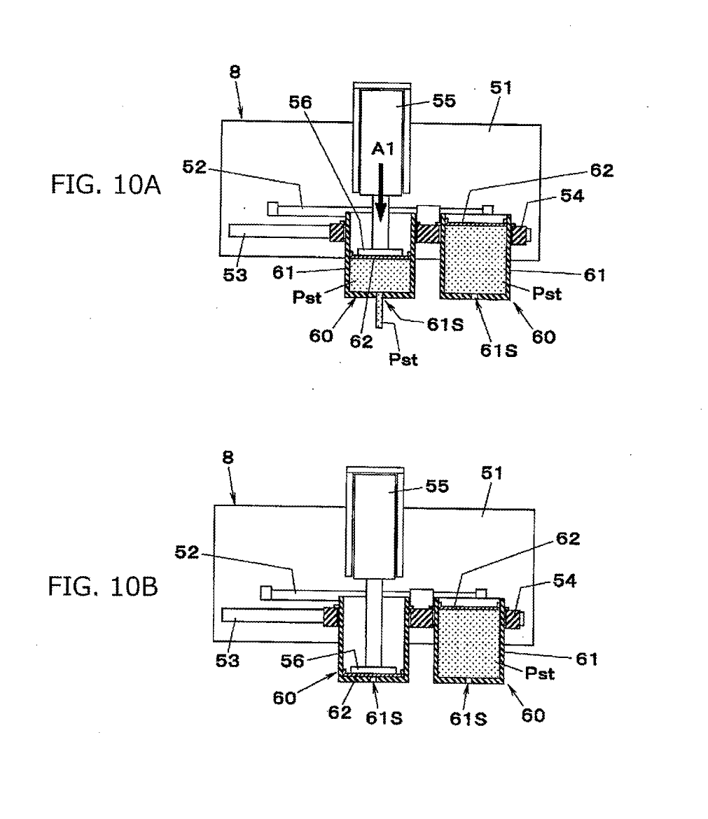

In FIG. 11, a controller 80 included in the screen printing machine 1 performs each control of operation of positioning in a work position and conveyance of the substrate 2 by the conveyance conveyors 16, operation of upward and downward movement (upward and downward movement of the lower receiving member 17) of the second elevation table 14 by the second elevation motor 14m, opening and closing operation of the clampers 18 by the clamper opening and closing cylinder 18s, parallel and rotational movement operation of the base table 12 with respect to the base 3 by the XYθ movement mechanism 11, and operation of upward and downward movement (contact of the substrate 2 with the mask 5 and separation of the substrate 2 from the mask 5) of the first elevation table 13 by the first elevation motor 13m. Also, the controller 80 performs each control of upward and downward movement operation of the squeegees 22 by the squeegee elevation cylinder 24, movement operation of the paste supply apparatus 8 in the Y-axis direction and the squeegee head 6 by the head movement motors 23b, movement operation of the paste supply apparatus 8 in the X-axis direction by the paste supply apparatus movement motor 44, and movement operation of the camera unit 7 by the camera unit movement mechanism 33 (FIG. 11). Also, the controller 80 performs each control of movement operation of the pot holding part 54 in the X-axis direction by the rod-less cylinder 52, ejection operation of the paste Pst from the paste pot 60 by the pressing cylinder 55, and generation operation of a suction force by negative pressure in the lower surface of the pad member 56 by the suction mechanism 59 (FIG. 11).

In FIG. 11, the controller 80 performs each control of imaging operation of the upward imaging camera 31 and imaging operation of the downward imaging camera 32. Each of the image data obtained by the upward imaging camera 31 and the downward imaging camera 32 is sent to the controller 80, and the controller 80 performs image recognition processing based on the image data in an image recognition part 80a (FIG. 11). Also, an input part 81 for performing various input manipulations is connected to the controller 80 (FIG. 11).

When screen printing work is executed by the screen printing machine 1 having such a configuration, the operator OP first fixes and holds the paste pot 60 in the pot holding part 54 in the manner described above (a pot holding step). Next, when the operator OP performs a screen printing work start manipulation from the input part 81, the conveyance conveyors 16 receive and convey the substrate 2 loaded from the outside of the screen printing machine 1, and position the substrate 2 in a work position. Then, the second elevation motor 14m upwardly moves the second elevation table 14 with respect to the first elevation table 13, and a lower surface of the substrate 2 is supported and lifted by the lower receiving member 17. Accordingly, after the substrate 2 is upwardly separated from the conveyance conveyors 16, the clampers 18 clamp the substrate 2.

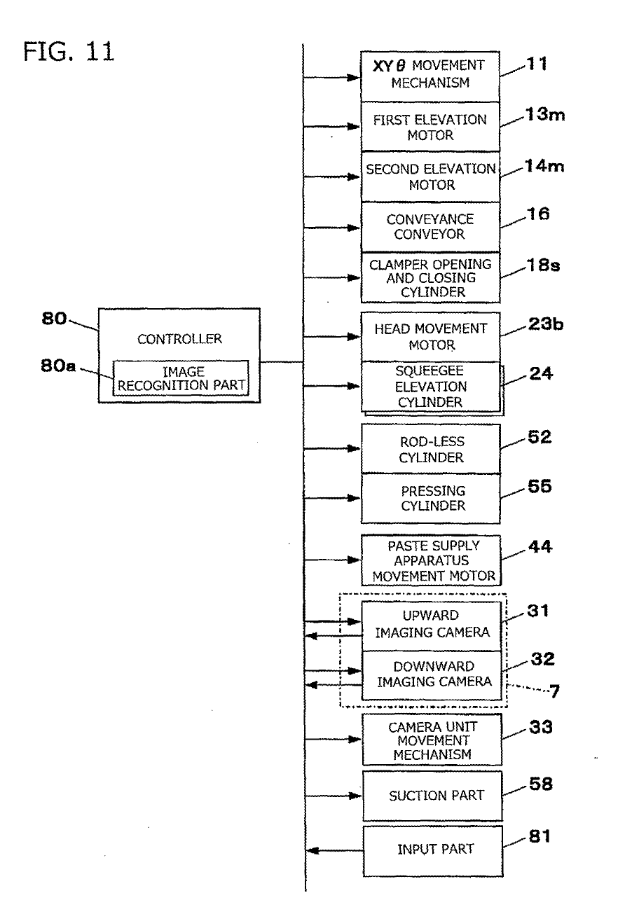

After the clampers 18 clamp the substrate 2, the camera unit 7 is moved under the mask 5, and the downward imaging camera 32 images the substrate side marks 2m from the upward side of the substrate 2, and the upward imaging camera 31 images the mask side marks 5m from the downward side of the mask 5. Image recognition of image data of the substrate side marks 2m and image data of the mask side marks 5m is performed in the image recognition part 80a of the controller 80 to obtain a position of the substrate 2 and a position of the mask 5. The XYθ movement mechanism 11 moves the substrate 2 based on the position of the substrate 2 and the position of the mask 5 obtained, and positions the substrate side marks 2m just under the mask side marks 5m (matches the substrate side marks 2m with the mask side marks 5m in plan view), and aligns the substrate 2 with the mask 5. After the XYθ movement mechanism 11 aligns the substrate 2 with the mask 5, the first elevation motor 13m upwardly moves the first elevation table 13 with respect to the base table 12 (arrow B shown in FIG. 12A), and brings the substrate 2 into contact with a lower surface of the mask 5.

After the substrate 2 is brought into contact with the mask 5, the head movement motors 23b move the movement base 21 in the Y-axis direction, and move the paste supply apparatus 8 over a portion of contact between the mask 5 and the clampers 18. Then, while the paste supply apparatus movement motor 44 moves the paste supply apparatus 8 in the X-axis direction, the paste supply apparatus 8 supplies the paste Pst to the mask 5. When the paste supply apparatus 8 supplies the paste Pst to the mask 5, as described above, the pressing cylinder 55 downwardly moves the pad member 56 abutted on the inner lid 62 of the paste pot 60 from the upward side and depresses the inner lid 62 inside the tubular container 61 to thereby eject the paste Pst from the through hole 61S (FIG. 12A, and a paste ejecting step).

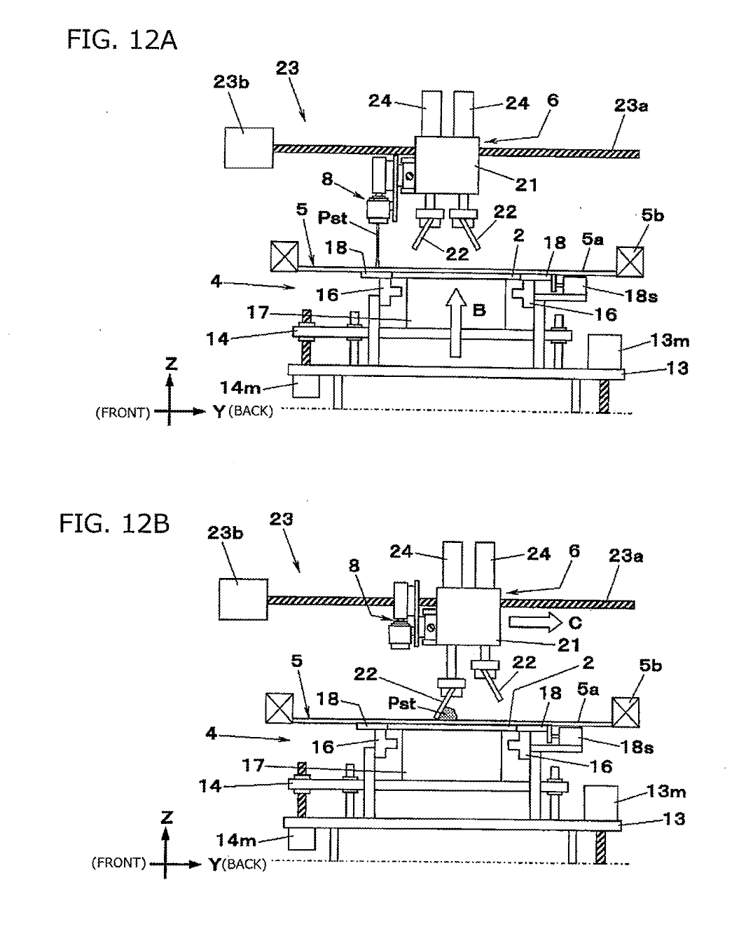

After the pressing cylinder 55 completes supplying an appropriate amount of paste Pst to the mask 5, the paste supply apparatus movement motor 44 stops movement of the paste supply apparatus 8 in the X-axis direction, and the pressing cylinder 55 stops depression of the inner lid 62 (FIG. 13A). Then, the suction mechanism 59 generates a suction force by negative pressure in the lower surface of the pad member 56 to suck the inner lid 62, and joins the inner lid 62 to the pad member 56. In addition, timing at which the suction mechanism 59 joins the inner lid 62 to the pad member 56 maybe the timing before the pressing cylinder 55 stops depression of the inner lid 62.

After the inner lid 62 is joined to the pad member 56, the pressing cylinder 55 upwardly moves the pad member 56, and pulls up the inner lid 62 with respect to the tubular container 61 fixed to the pot holding part 54 (arrow A2 shown in FIG. 13B). This pull-up of the inner lid 62 attempts to upwardly move the whole paste pot 60, but the tubular container 61 of the paste pot 60 is fixed to the pot holding part 54 (upward and downward movement is regulated) by the pot fixture 70, with the result that the tubular container 61 stays in the pot insertion holes 54H and the inner lid 62 is upwardly moved relatively with respect to the tubular container 6 Accordingly, negative pressure is generated inside the tubular container 61 and the paste Pst coming out of the through hole 61S is sucked up inside the tubular container 61 (a paste suck-up step, and FIG. 13B), with the result that a situation in which the paste Pst coming out of the through hole 61S directly drips under its own weight is prevented.

As the paste Pst, solder paste having thixotropy properties is often used. When the paste Pst is ejected from the through hole 61S by the pressing cylinder 55, a shear rate associated with movement of the paste Pst is generated in the paste Pst of the inside of the paste pot 60 and viscosity of the paste Pst having thixotropy properties decreases gradually. As a result, the paste Pst immediately after depression of the inner lid 62 by the pressing cylinder 55 is stopped is in an easy-to-fluidize state. Moreover, the paste Pst immediately after depression of the inner lid 62 is stopped is in a state pressurized by a force by which the tubular container 61 swelling by pressure at the time of depressing the inner lid 62 returns to the original shape. As a result, an outflow of the paste Pst from the through hole 61S does not stop easily by only stopping downward movement of the pad member 56. Hence, the first embodiment is constructed so as to stop the outflow of the paste Pst from the through hole 61S by generating negative pressure inside the tubular container 61 by forcedly pulling up the inner lid 62 in a state joined to the pad member 56 using the pressing cylinder 55.

In the first embodiment thus, the suction mechanism 59 forms a joining part that joins the inner lid 62 to the pad member 56. Also, the pressing cylinder 55 forms a pad member elevation part that upwardly and downwardly moves the pad member 56 inside the tubular container 61 of the paste pot 60, and the controller 80 forms a control part that controls the pad member elevation part (the pressing cylinder 55) to execute operation in which the pad member 56 is downwardly moved to depress the inner lid 62 in order to eject the paste Pst from the through hole 61S and the joining part (the suction mechanism 59) upwardly moves the pad member 56 joined to the inner lid 62 to pull up the inner lid 62 in order to stop ejection of the paste Pst from the through hole 61S. In addition, the amount of pull-up of the inner lid 62 by the pressing cylinder 55 can be adjusted by managing pull-up time of the pad member 56 by the pressing cylinder 55, and an appropriate amount (normally, about several millimeters) of pull-up of the inner lid 62 can be obtained by experiment, numerical simulation, etc.

FIG. 13C shows the inside of the tubular container 61 in the case of setting the amount of pull-up of the inner lid 62 at a large value. A cavity part K is formed by air sucked from the through hole 61S between the inner lid 62 and the paste Pst. This cavity part K is formed in a pipe shape upwardly extending from the through hole 61S. When the inner lid 62 is pulled up until the cavity part K upwardly extending from the through hole 61S is generated in the paste Pst in this manner, the paste Pst becomes absent just over the through hole 61S, with the result that drips of the paste Pst can be prevented more surely. Particularly, since the paste Pst having thixotropy properties becomes hard in a state released from pressure and the shape of the paste Pst tends to be held, the effect of preventing the drips is remarkable when the paste Pst to be used is solder paste.

After the paste supply apparatus 8 supplies the paste Pst to the mask 5 as described above, one squeegee elevation cylinder 24 downwardly moves the squeegee 22 and abuts the lower end of the squeegee 22 on the mask 5, and the head movement motors 23b move the movement base 21 in the Y-axis direction (arrow C shown in FIG. 12B). Accordingly, the squeegee 22 is slid on the mask 5, and scrapes the paste Pst on the mask 5, and fills the pattern holes 5h of the mask 5 with the paste Pst.

After the squeegee 22 fills the pattern holes 5h of the mask 5 with the paste Pst as described above, the first elevation motor 13m downwardly moves the first elevation table 13 and separates the substrate 2 from the mask 5 to snap off. After the snap-off is completed, a pair of clampers 18 is opened and releases clamping of the substrate 2, and the second elevation motor 14m downwardly moves the second elevation table 14 and lowers the substrate 2 on the conveyance conveyors 16. Then, after the conveyance conveyors 16 carry out the substrate 2 to the outside of the screen printing machine 1, the screen printing work per sheet of the substrate 2 is completed.

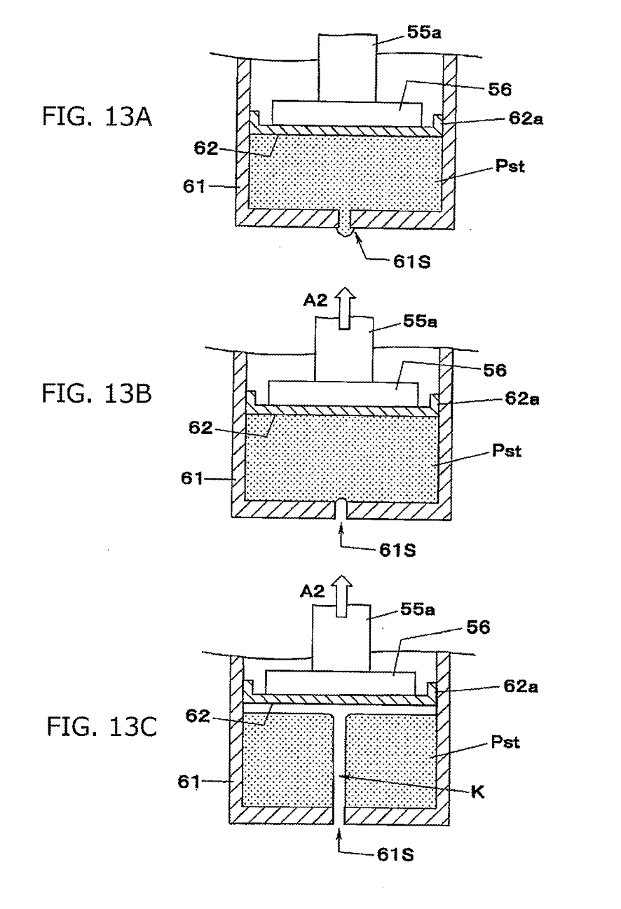

When the paste pot 60 in use becomes empty (the paste Pst of the inside of the tubular container 61 becomes empty) during the screen printing work described above, the operator OP performs a necessary manipulation from the input part 81 and actuates the pressing cylinder 55 and upwardly moves the pad member 56 inside the tubular container 61 to thereby pull the pad member 56 to the upward side of the tubular container 61 (arrow A3 shown in FIG. 14A). Then, the rod-less cylinder 52 is actuated and the empty paste pot 60 is moved in the pot attachment and detachment position (arrow D shown in FIG. 14B). After such a state, the operator OP upwardly pulls the empty paste pot 60 out of the pot insertion hole 54H (arrow E shown in FIG. 14B), and inserts a new paste pot 60 into the pot insertion hole 54H instead of this empty paste pot 60.

When the pad member 56 is pulled out of the tubular container 61, the suction mechanism 59 is constructed so as to release generation of a suction force by negative pressure in the lower surface of the pad member 56 and separate the inner lid 62 from the pad member 56. As a result, the inner lid 62 of the used paste pot 60 stays in the empty tubular container 61, and the operator OP can discard the tubular container 61 and the inner lid 62 in an integrated state.

As described above, the screen printing machine 1 (paste supply apparatus 8) in the first embodiment is constructed so that the pad member 56 abutted on the inner lid 62 of the paste pot 60 from the upward side is downwardly moved and the inner lid 62 is depressed inside the tubular container 61 to thereby eject the paste Pst from the through hole 61S and then the pad member 56 joined to the inner lid 62 is upwardly moved to pull up the inner lid 62 to thereby suck up the paste Pst dripping from the through hole 61S inside the tubular container 61, with the result that drips of the paste Pst at the time of stopping ejection of the paste Pst can be prevented. Also, accordingly, a waste of the paste Pst is decreased and working of wiping the dripping paste Pst is also eliminated, with the result that productivity can be improved.

### Second Embodiment

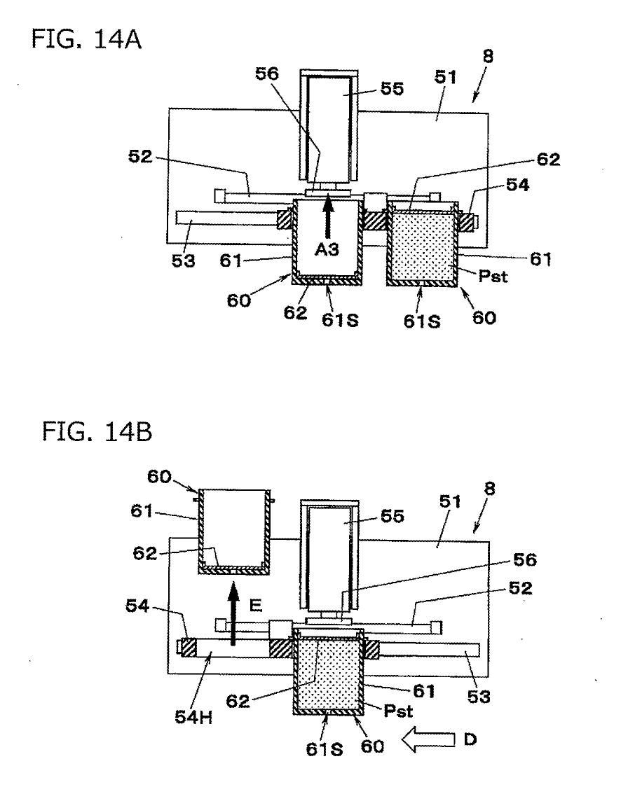

A screen printing machine in a second embodiment is substantially the same as the screen printing machine 1 in the first embodiment described above, but differs from the screen printing machine 1 in a configuration of a joining part. That is, in the second embodiment, as shown in FIGS. 15A and 15B, a lower surface side of a pad member 56 is provided with a sucker 90 for sucking a inner lid 62, and the sucker 90 forms the joining part that joins the inner lid 62 to the pad member 56. The sucker 90 is fixed to a lower surface of the pad member 56 by a fixture 91, and when the pad member 56 is pushed on the inner lid 62 from the upward side (arrow A1 shown in FIG. 15B), the sucker 90 is deformed so as to spread out in a crushed shape and sticks to an upper surface of the inner lid 62 (FIG. 15B). As shown in FIG. 15B, the whole sucker 90 (particularly, an outer edge part 90a) sticking to an upper surface of the inner lid 62 is configured to be pushed on the inner lid 62 by the lower surface of the pad member 56, and the sucker 90 adheres tightly to the inner lid 62 with high adhesion, with the result that the inner lid 62 is tightly joined to the pad member 56.

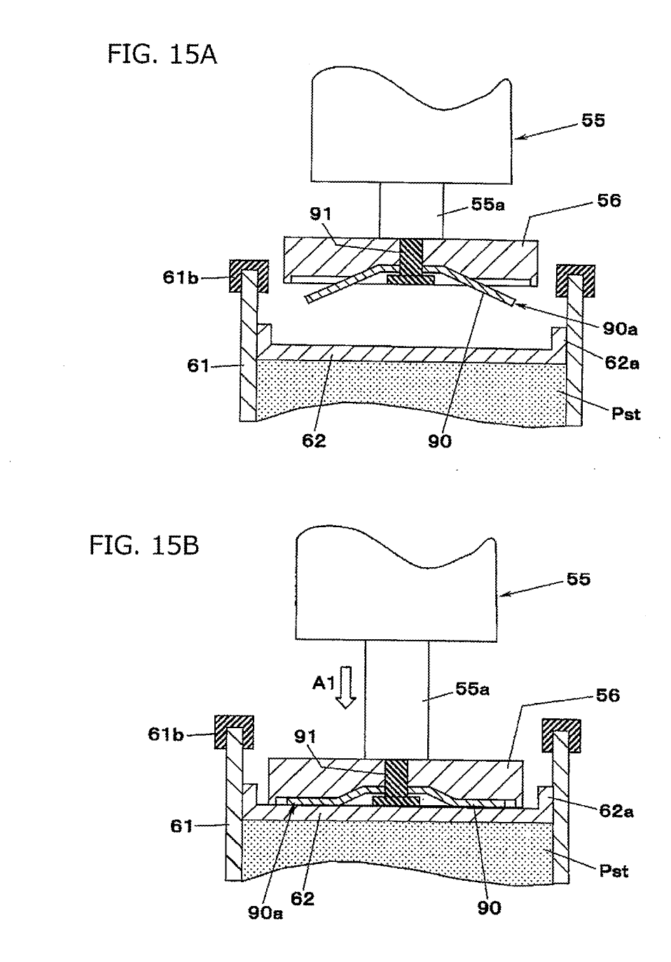

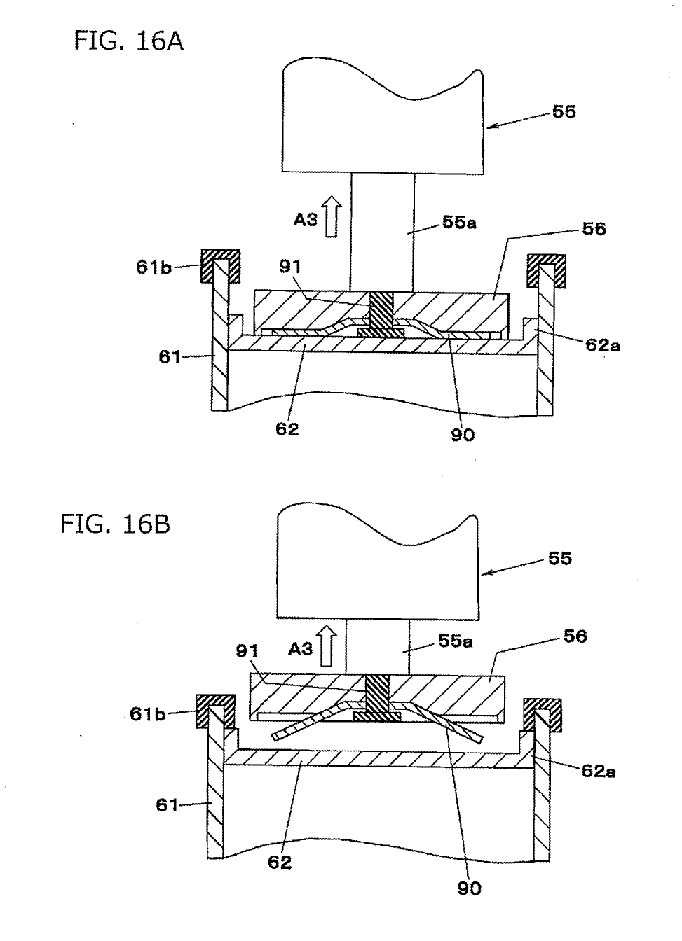

As shown in FIGS. 15A, 15B and 16A, 16B, in the second embodiment, a ring-shaped member 61b is fitted into the upper edge of a tubular container 61 after a paste pot 60 is inserted into a pot insertion hole 54H of the pot holding part 54. When the pad member 56 is upwardly moved at the time of replacement of the paste pot 60, a folded-back part 62a of the inner lid 62 upwardly moved integrally to the pad member 56 interferes with the ring-shaped member 61b, and subsequent upward movement is regulated (FIG. 16A) and by further upward movement of the pad member 56, the pad member 56 is torn from the sucker (FIG. 16B). As a result, like the case of the first embodiment, the inner lid 62 of the used paste pot 60 stays in the empty tubular container 61, and the tubular container 61 and the inner lid 62 can be discarded in an integrated state. Thus, the second embodiment can also obtain an effect similar to that of the case of the first embodiment.

In addition, as a modified example of the second embodiment, a member (an adhesive member) having adhesion properties may be used instead of the sucker 90. By sticking the adhesive member on the lower surface side of the pad member 56, the adhesive member sticks to the pad member 56 like the case of the sucker 90 when the pad member 56 is pushed on the inner lid 62 from the upward side, with the result that an effect similar to that of the case of the second embodiment described above can be obtained. Also, a mode showing the first embodiment and the second embodiment, that is, the sucker formed in the lower surface of the pad member 56 and a mechanism constructed so that a suction force by negative pressure can be generated inside the sucker can be adopted.

A paste supply apparatus, a screen printing machine and a paste supply method capable of preventing drips of paste at the time of stopping ejection of the paste are provided.

What is claimed is:

1. A paste supply apparatus comprising:
a pot holding part that fixes and holds a paste pot that includes a tubular container which receives paste and is provided with a through hole in a bottom part of the tubular container and an inner lid movable inside the tubular container, in a posture in which the through hole faces downwardly;
a pad member that abuts on an upper surface of the inner lid of the paste pot held in the pot holding part;
a pad member elevation part that upwardly and downwardly moves the pad member inside the tubular container;
a joining part that joins the inner lid to the pad member; and
a control part that controls the pad member elevation part to execute operation in which the pad member is downwardly moved to depress the inner lid in order to eject paste from the through hole and the pad member joined to the inner lid by the joining part is upwardly moved to pull up the inner lid in order to stop ejection of the paste from the through hole.

2. The paste supply apparatus according to claim 1, wherein the joining part includes a suction mechanism that generates a suction force by negative pressure in a suction hole opened in a lower surface of the pad member to suck the inner lid.

3. The paste supply apparatus according to claim 1, wherein the joining part includes a sucker that is provided in a lower surface of the pad member and sucks the inner lid.

4. A screen printing machine that prints paste on a substrate, the screen printing machine comprising:
a squeegee that slides on a mask stacked on the substrate; and
a paste supply apparatus that supplies paste to the mask,
wherein the paste supply apparatus comprises:
a pot holding part that fixes and holds a paste pot that includes a tubular container which receives paste and is provided with a through hole in a bottom part of the tubular container and an inner lid movable inside the tubular container, in a posture in which the through hole faces downwardly;
a pad member that abuts on an upper surface of the inner lid of the paste pot held in the pot holding part;
a pad member elevation part that upwardly and downwardly moves the pad member inside the tubular container;
a joining part that joins the inner lid to the pad member; and
a control part that controls the pad member elevation part to execute operation in which the pad member is downwardly moved to depress the inner lid in order to eject paste from the through hole and the pad member joined to the inner lid by the joining part is upwardly moved to pull up the inner lid in order to stop ejection of the paste from the through hole.

5. A paste supply method using a paste pot that includes a tubular container which receives paste and is provided with a through hole in a bottom part of the tubular container and an inner lid movable inside the tubular container, the method comprising:
a pot holding step of fixing and holding the paste pot in a posture in which the through hole faces downwardly;
a paste ejecting step of ejecting paste from the through hole by downwardly moving a pad member abutted from above on the inner lid of the paste pot held in the pot holding step and depressing the inner lid inside the tubular container; and
a paste suck-up step of sucking up paste dripping from the through hole inside the tubular container by depressing the inner lid in the paste ejecting step and then upwardly moving the pad member joined to the inner lid and pulling up the inner lid.
